(19) United States
(12) Patent Application Publication
(10) Pub. No.: US 2005/0166406 A1
(43) Pub. Date: Aug. 4, 2005

(54) Utensil having integrated lip

(76) Inventor: Randall Cornfield, Montreal (CA)

Correspondence Address: Louis Tessier, P O Box 54029, Town of Mount-Royal, QC, H3P 3H4, CA

(21) Appl. No.: 10/513,727

(22) PCT Filed: May 12, 2003
(86) PCT No.: PCT/CA03/00663

Related U.S. Application Data
(60) Provisional application No. 60/379,703, filed on May 10, 2002.
(60) Provisional application No. 60/379,698, filed on May 10, 2002.
(60) Provisional application No. 60/379,636, filed on May 10, 2002.
(60) Provisional application No. 60/379,634, filed on May 10, 2002.

(51) Int. Cl. A47J 43/28

(52) U.S. Cl. 30/324

(57) ABSTRACT

An improved utensil such as a spatula, spoon, ladle or the like wherein there is provided a lip portion extending outwardly from one of the corners formed where a front edge meets a side edge, the lip portion assisting in the scraping or mixing of contents in a container which has a circular configuration and an arcuate merging section between the side wall and base thereof.

### FIELD OF THE INVENTION

The present invention relates to an improvement in a utensil and more particularly, relates to an improvement in utensils suitable for use in the culinary arts.

### BACKGROUND OF THE INVENTION

The field of utensils which are suitable for use in the culinary field is replete with many different proposals for different types of utensils. Thus, there are provided spoons and spatulas of different sizes and configurations depending upon the final use of the device. However, to-date, none of the devices known to applicant are able to satisfactorily be used in bowls or pans, or the like which typically have an arcuate configuration and an arcuate or otherwised shaped merging section between the side wall and base thereof.

A number of different types of utensils are known in the art. Thus, reference may be had to U.S. Pat. No. 3,092,411 to Hardy which discloses a conventional type of spatula having a straight front edge. Such spatulas are widely available.

A modified version of a spatula is shown in U.S. Pat. No. 5,794,996 wherein an angled front edge is utilized. The spatula has rounded corners to assist in the manipulation of food.

Spatulas having pointed portions are also known in for example, U.S. Pat. No. 901,671 which discloses a spatula having a leading edge or point at the center thereof.

Spoons or like articles having an arcuate corner configuration are known and thus, reference may be had to U.S. Pat. No. Design 9,204,296 which discloses such a article.

However, despite the number of utensils which are known, many such devices are not suitable for fully reaching into the corners of a pan or pot to manipulate the food ingredients.

Thus, when utilizing the utensil with a bowl or a pan or the like which have such a merging arcuate section, it is impossible to fully scrape this portion of the bowl or pan. As will be appreciated, this is often desirable when one is mixing, stirring or otherwise manipulating the contents of the bowl or pan.

### SUMMARY OF THE INVENTION

It is therefore an object of the present invention to provide an improved utensil suitable for use in the culinary arts and which utensil has means for removing the material from the corner of a pan, pot, bowl, or the like.

According to one aspect of the present invention, in an utensil having a food contacting member, there is provided an improvement wherein the food contacting member has a first side edge, a second side edge and a front edge extending between the side edges, a first corner being formed where the first side edge meets the front edge and a second corner being formed where the second side edge meets the front edge; and a lip portion extending forwardly from the front edge substantially adjacent the first corner, the lip portion having an outline comprising a first segment which is substantially a continuation of the first side edge, a second segment comprising a front edge segment and a third side segment which extends from the front edge segment inwardly to meet the front edge of the food contacting member, the lip portion extending forwardly from the front edge a distance greater than any other protrusion on the front edge.

According to one aspect of the present invention, there is provided a utensil comprising a handle, a member connected to the handle, the member having a first side edge, a second side edge and a front edge extending between the side edges, a first corner being formed where the first side edge meets the front edge, and a second corner being formed where the second side edge meets the front edge, and a lip portion extending outwardly, the lip portion being located at one of the corners, the lip portion extending beyond a plane which is substantially tangential to the front edge at a point substantially intermediate the side edges.

According to a further aspect of the present invention, there is provided, in a utensil having a food contacting member, the improvement wherein the food contacting member has a first side edge, a second side edge and a front edge extending between the side edges, a first corner being formed where the first side edge meets the front edge, and a second corner being formed where the second side edge meets the front edge, and a lip portion extending outwardly, the lip portion being located at one of the corners, the lip portion extending beyond a plane which is substantially tangential to the front edge at a point substantially intermediate the side edges.

As used in the present application, the term utensil includes within its scope any implement which may be used in the culinary arts for the purpose of mixing, dispensing, lifting, serving, separating, or a like operation. Some of the commonly known implements include, for example, those commonly described as spatulas, different types of spoons, ladles, etc. All of these implements are generally characterized by having a handle portion and a food contacting portion. The handle portion usually comprises an elongated member which may have many different configurations and which is either permanently or temporarily attached to the food contacting portion. The food contacting portion, depending upon the ultimate purpose of the utensil, may have a relatively flat upper and bottom surface as is the case in most spatulas. Alternatively, in the case of ladles and spoons and the like, the upper surface is generally of a concave configuration.

In all of the above instances, the utensil generally has a pair of side edges and a front edge. In some instances, the side edges and the front edge are substantially linear in configuration while in other embodiments, such as many spoons and ladles, both the front and side edges may have a substantially arcuate configuration with the front edge merging substantially arcuately with the side edges.

The present invention is designed to be used with all of the aforementioned configurations. In general, as stated above, there are provided a pair of opposed side edges and a front edge, with first and second corners being formed where the front edge meets the first and second side edges.

According to the present invention, there is provided a lip which extends forwardly from the front edge substantially adjacent the first corner, the lip having an outline which comprises a first segment which is substantially a continuation of the first side edge, a second segment which comprises a front edge, a third side segment which extends from the front edge segment inwardly to meet the front edge of the food contacting member. The lip portion is characterized as extending forwardly from the front edge a distance greater than any other protrusion on the front edge.

In another aspect of the present invention, there is provided an arrangement wherein the food contacting portion includes a lip which extends outwardly, the lip being located substantially adjacent one of the corners and the lip extending beyond a plane which is substantially tangential to the front edge at a point substantially intermediate the side edges.

In a greater detail, when reference is had to a plane which is substantially tangential to the front edge at a point substantially intermediate the side edges, it will be understood that this plane is taken at a point which may vary. In general terms, it is generally preferred to take the tangential point at a position which is spaced substantially equidistantly inwardly from the side edges. In the case of a utensil having a straight front edge, such as many spatulas, it is irrelevant at what point the plane is measured at since it would be a common plane at all points (except for the lip portion).

In the case of a curved front edge, the center point will generally be the most forward extending point (except for the lip) in a conventional spoon or ladle type of implement. It suffices to say that one skilled in the art would be readily able to establish the location of such a tangential plane.

### BRIEF DESCRIPTION OF THE DRAWINGS

Having thus generally described the invention, reference will be made to the accompanying drawings illustrating an embodiment thereof, in which:

FIG. 1 is a perspective view of one embodiment of a utensil according to the present invention;

FIG. 2 is a perspective view of a second embodiment of a utensil according to the present invention;

FIG. 3 is a partial detailed view of the food contacting portion of the utensil shown in FIG. 1;

FIG. 4 is a partial detailed side view of the food contacting portion of the utensil shown in FIG. 1;

FIG. 5 is a detailed view of the lip portion thereof; and

FIG. 6 is a top plan view of a spatula according to one embodiment of the present invention;

FIG. 7a is a perspective view as seen from the left hand side of FIG. 6;

FIG. 7b is a perspective view illustrating an alternative embodiment of the invention;

FIG. 7c is a perspective view illustrating an alternative embodiment of the invention;

FIG. 7d is a perspective view illustrating an alternative embodiment of the invention;

FIG. 8a is a top plan view of a still further version of a spatula according to the present invention;

FIG. 8b is a top plan view of a still further version of a spatula according to the present invention;

FIG. 9 is a bottom plan view of a potato masher according to the present invention;

FIG. 10a is a top view of a ladle having a lip in accordance with an alternative embodiment of the present invention;

FIG. 10b is an elevational view showing the ladle of FIG. 10a;

FIG. 10c is a perspective view showing the ladle of FIG. 10a;

FIG. 10d is an elevational view showing an alternative embodiment of a ladle in accordance with an embodiment of the invention;

### DESCRIPTION OF THE PREFERRED EMBODIMENT

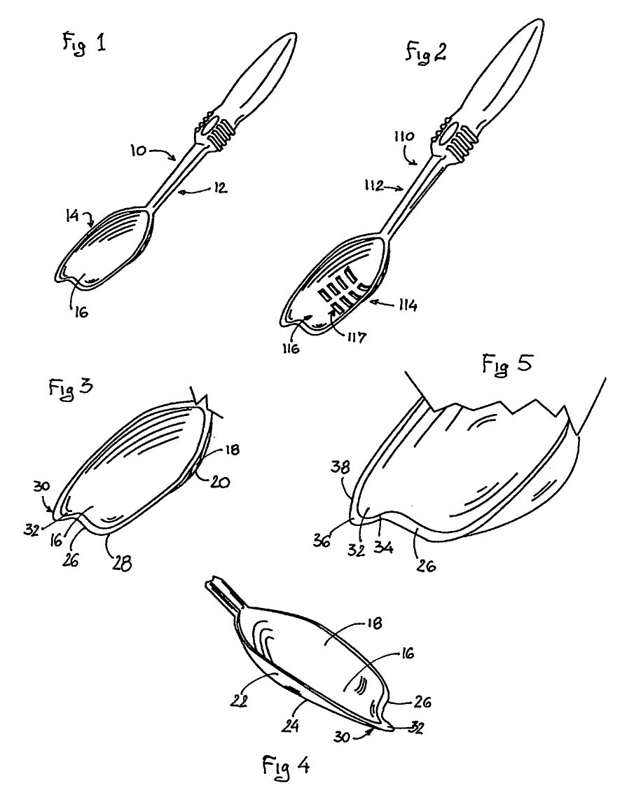

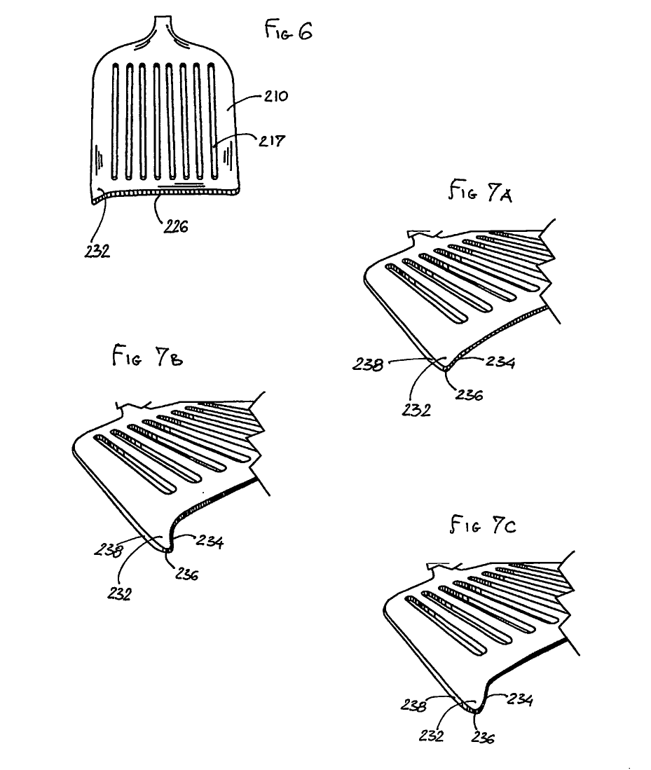

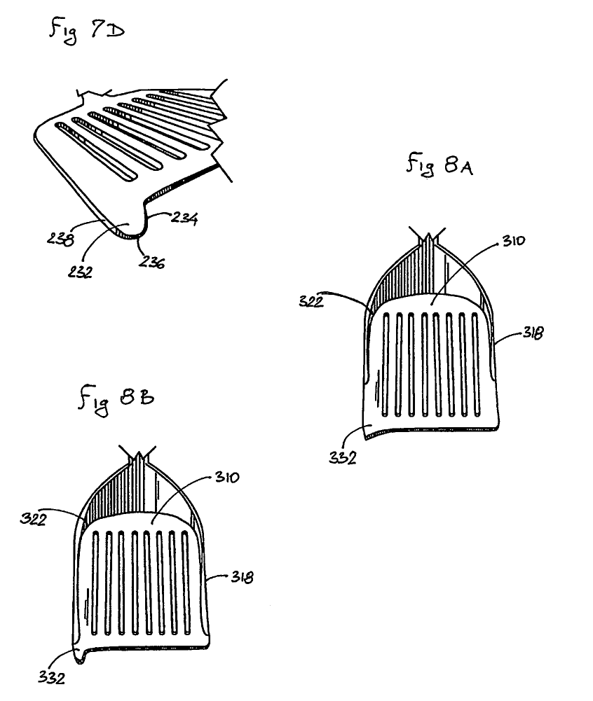

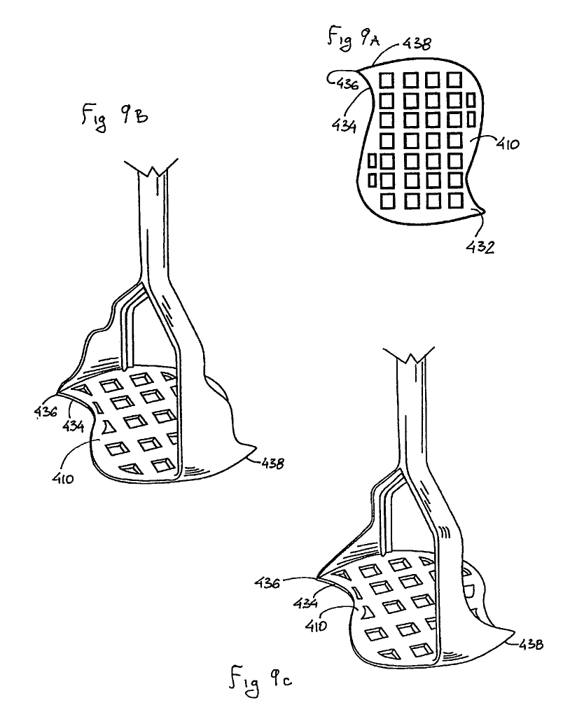

Referring to the drawings in greater detail, and by reference characters thereto, there is illustrated in FIG. 1 a utensil which is generally designated by reference numeral 10.

Utensil 10 is comprised of a handle 12 and a food contacting portion generally designated by reference numeral 14. Food contacting portion 14 includes a base wall 16 which has a first side edge 20. A first side wall 18 extends upwardly from side edge 20. Similarly, there is provided a second opposed side edge 24 having an upwardly extending second side wall 22.

Extending between side edges 20 and 24 is a front edge generally designated by reference numeral 26.

The merger of side edge 20 and front edge 26 provides a first corner 28, while a second corner 30 is provided where second side edge 24 merges with front edge 26.

According to the present invention, there is provided a lip which is generally designated by reference numeral 32. As may be best seen in FIG. 5, lip 32 includes a first segment 38 which is substantially a continuation of side edge 24. This in turn merges with a second segment which is a front edge segment designated by reference numeral 36, and a third side segment 34 which extends from the front edge segment 36 inwardly to meet the front edge 26 of the instrument.

Lip 32 is characterized as extending beyond a plane which is tangential to the front edge of the food contacting portion 14 at a point which is intermediate side edges 20 and 24.

The embodiment of FIG. 2 is substantially the same as that of FIG. 1 with minor modifications thereto. Thus, there is provided a utensil 110 having a handle 112 and a food contacting portion 114. A bottom wall 116 is provided with a plurality of apertures 117 therein.

As shown in FIG. 6, there may be provided a spatula generally designated by reference numeral 210. Reference numerals similar to those previously utilized are employed in this embodiment, but are numbered in the 200's. Thus, as may be seen, there is provided a lip 232 which extends forwardly of the front edge of the spatula at a first corner thereof. As may be seen, a plurality of elongated slots or apertures 217 are provided therein.

In the embodiment of FIG. 8, utensil 310 is similar to that shown in FIGS. 6 and 7. However, there are provided a pair of upwardly extending side walls 322 and 318 extending upwardly from the side edges. It is to be noted that side walls 322 and 318 terminate short of the corners.

In FIG. 9, there is shown a utensil 410 which is in the form of a potato masher. In this embodiment, there is again provided a utensil 410 with a food contacting portion 414 which has a lip 432 and which has an outline or configuration which comprises a first segment 438 which is a continuation of the side wall 440, a front segment 436, and a second side segment 434 which extends inwardly. It should be understood that the front segment 436 may have any suitable configuration without departing from the scope of the present invention. For example, the front segment 436 may have a substantially curved or arcuate configuration, a substantially rectilinear configuration or, as illustrated in FIG. 9 a substantially pointed configuration defined by segments 438 and 434 meeting at a relatively sharp angle.

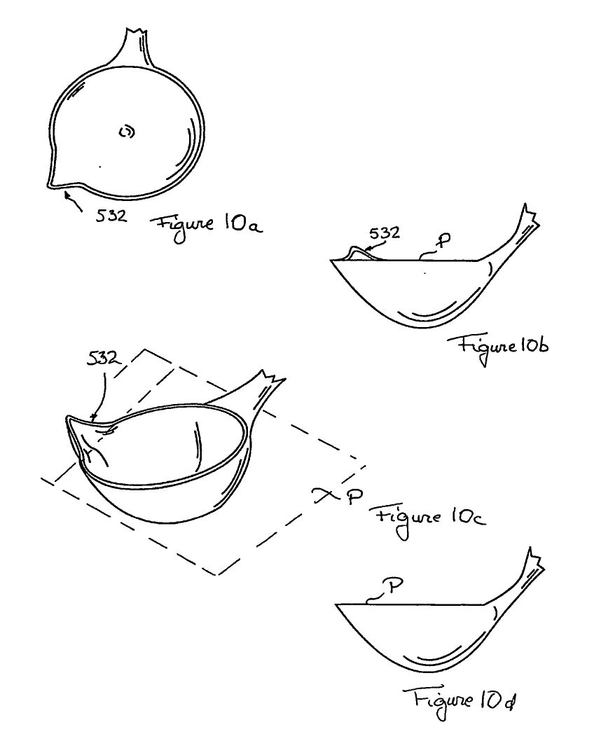

In yet another alternative embodiment of the invention illustrated in FIGS. 10a through 10d, the utensil is a ladle-type of implement. The ladle includes a substantially concave ladle wall defining a wall peripheral edge. FIGS. 10a, 10b and 10c illustrate an embodiment wherein the food contacting portion defines a generally horizontal reference plane P and wherein the lip 532 protrudes at an angle relative to the reference plane P. FIG. 10d illustrates an embodiment wherein the lip 532 does not protrude from the reference plane P.

The fact that the lip 532 protrudes from the reference plane P facilitates ergonomical positioning of the lip 532 relative to the corner sections of culinary vessels in certain situations. In the case of a ladle, the reference plane P is defined as coinciding with the wall peripheral edge. It should be understood that the concept of having the lip protrude substantially outwardly or at an angle from a substantially horizontal reference plane could apply to other types of utensils or implements without departing from the scope of the present invention. For example, in the case of a spatula, the reference plane could extend in a coplanar relationship with the food contacting plate. In the case of a spoon the reference plane could extend in a coplanar relationship with the peripheral edge of the spoon.

In each of the above cases, the lip portion is designed to facilitate the removal of food contents from corners of pans and the like. This is extremely useful when mixing or otherwise manipulating the food while cooking. In the case of the potato masher 410, lip 432 ensures that the masher reaches right into the corners of the container.

It will be understood that the above described embodiment is for purposes of illustration only and that changes or modifications may be made thereto without departing from the spirit and scope of the invention.

1. In a utensil having a food contacting member, an improvement wherein said food contacting member has a first side edge, second side edge and a front edge extending between said side edges, a first corner being formed where said first side edge meets said front edge and a second corner being formed where said second side edge meets said front edge; and
a lip portion extending substantially forwardly from said front edge adjacent said first corner, said lip portion having an outline comprising a first segment which is substantially a continuation of said first side edge, a second segment comprising a front edge segment and a third side segment which extends from said front edge segment inwardly to meet said front edge of said food contacting member, said lip portion extending outwardly from said front edge a distance sufficient to enable said lip to fit within a surface extending between side and bottom walls of a food container.

2. The improvement of claim 1 wherein said lip portion extends forwardly of said front edge a distance greater than any other protrusion on said front edge.

3. The improvement of claim 2 wherein said front edge has a generally straight outline between said lip and said second corner.

4. The improvement of claim 3 wherein said food contacting member is in the form of a spatula having a substantially flat top surface and a substantially flat bottom surface.

5. The improvement of claim 4 further including a first side wall extending substantially upwardly along a portion of said first side edge and a second side wall extending substantially upwardly along a portion of said second side edge, said first and second side wails terminating before said first and second corners.

6. The improvement of claim 4 further including apertures extending between said top and bottom surfaces.

7. The improvement of claim 2 wherein said member is in the form of a spoon having a substantially concave upper surface and a substantially convex bottom surface.

8. In a utensil having a food contacting member, the improvement wherein said food contacting member has a first side edge, a second side edge and a front edge extending between said side edges, a first corner being formed where said first side edge meets said front edge, and a second corner being formed where said second side edge meets said front edge; and
a lip portion extending substantially outwardly, said lip portion being located substantially adjacent said first corner, said lip portion extending beyond a plane which is substantially tangential to said front edge at a point substantially intermediate said side edges.

9. The improvement of claim 8 wherein said lip comprises a non-apertured solid portion.

10. The improvement of claim 9 wherein said lip extends forwardly of said front edge, said lip being defined by a first segment which is an extension of said first side wall and an arcuate wall portion merging with said front edge.

11. The improvement of claim 10 wherein said front edge has a generally straight outline between said lip and said first corner.

12. The improvement of claim 11 wherein said member is in the form of a spatula having a substantially flat top surface and a substantially flat bottom surface.

13. The improvement of claim 10 further including a first side wall extending upwardly from a portion of said first side edge, and a second side wall extending upwardly along a portion of said second side edge, said side walls terminating short of said corners.

14. The improvement of claim 12 wherein said member further includes apertures extending between said top and bottom surfaces.

15. The improvement of claim 14 wherein said apertures are elongated slots.

16. The utensil of claim 10 wherein said member is in the form of a spoon having a curved upper surface and a curved bottom surface.

17. An improved method for manipulating food in a container and wherein the container has a size wall merging with a bottom wall, the method comprising the step of providing a utensil having a handle and a food contacting member, the food contacting member having a first side edge, a second side edge, a front edge extending between said side edges, a first corner being formed where said first side edge meets said front edge and a second corner being formed where said second side edge meets said front edge, and a lip portion extending substantially forwardly from said front edge adjacent said first corner, said lip portion having an outline comprising a first segment which is substantially a continuation of said first side edge, a second segment comprising a front edge segment and a third side segment which extends from said front edge segment inwardly to meet said front edge of said food contacting member, and utilizing said utensil such that said lip portion fits within said merging portion of said container to provide access thereto.

18. A culinary implement comprising:
a food contacting portion, said food contacting portion extending substantially in a reference geometrical plane, said food contacting portion defining a contacting portion first side edge, a contacting portion second side edge and a contacting portion front edge extending substantially between said contacting portion first and second side edges;
a scraping tongue extending substantially forwardly from said contacting portion front edge, said scraping tongue defining a tongue first side edge, a tongue second side edge and tongue front edge extending between said tongue first and second side edges;
at least one of said tongue first or second side edges extending at an angle relative to said contacting portion front edge.

19. A culinary implement as recited in claim 18 wherein both of said tongue first and second side edges extend at an angle relative to said contacting portion front edge.

20. A culinary implement as recited in claim 18 wherein said tongue first side edge extends substantially collinearly from said contacting portion first side edge.

21. A culinary implement as recited in claim 18 wherein said scraping tongue extends substantially upwardly from said reference geometrical plane.
